(19) United States
(12) Patent Application Publication
(10) Pub. No.: US 2021/0040955 A1
(43) Pub. Date: Feb. 11, 2021

(54) Windmill Style Ceiling Fan

(71) Applicant: Quorum International, Inc., Fort Worth, TX (US)

(72) Inventor: Aaron M. Johnson, Austin, TX (US)

(73) Assignee: Quorum International, Inc., Fort Worth, TX (US)

(21) Appl. No.: 16/719,116

(22) Filed: Dec. 18, 2019

Related U.S. Application Data
(60) Provisional application No. 62/783,376, filed on Dec. 21, 2018.

(51) Int. Cl. F04D 29/38; F04D 25/08; F04D 29/00

(52) U.S. Cl. CPC F04D 29/382; F04D 25/088; F04D 29/388; F05D 2300/614; F04D 29/005; F05D 2300/6012; F04D 29/384

(57) ABSTRACT

A windmill-type electric ceiling fan having a fan blade assembly which is light weight, exhibits improved air flow, and quieter operation. The ceiling fan has a hub attached to a motor shaft which depends from a ceiling support. A series of fan blades are each attached at an inward end to the hub and are supported radially by an elongated leading edge member, a trailing edge member and an outer edge member. The fan blade include panels which are constructed of fabric that is secured to leading edge and trailing edge members configured to dispose the pitch of the fan blades at an efficient and quiet angle.

### 1. CROSS-REFERENCE TO RELATED APPLICATION

The present application claims priority from U. S. Provisional Patent Application Ser. No. 62/783,376 filed Dec. 21, 2018, by the same inventor and with the same title.

### BACKGROUND OF THE INVENTION

### 1. Field of the Invention

The present invention relates to electric ceiling fans having a windmill aspect to their appearance and, more particularly, to the fan blade structures of such ceiling fans.

### 2. Background of the Invention

Windmills have been used for centuries to convert wind power to other useful ends, such as in pumping water or in providing electrical power. In recent years, windmill ceiling fans, reminiscent of traditional windmills found on farms and ranches, have become increasingly popular. These fans either incorporate the components of old windmills, or are newly manufactured from new components. They make attractive interior or exterior placements using standard electrical service. Special ceiling supports are generally not required. Whether hung in a cathedral ceiling, urban loft, great room, or outdoor kitchen/patio, these fans provide a pleasing esthetic centerpoint to complete any room.

Most people are familiar with the design of a traditional ceiling fan. The traditional ceiling fan will typically include a downrod suspended from the ceiling, a motor having a motor shaft connected to a lower portion of the downrod and a motor body which rotates about the motor shaft. A motor housing is secured to either the motor shaft or the downrod assembly which is stationary and surrounds the motor. Blade mounting irons connect to the motor body and extend out of a lower opening of the motor housing. The fan blades are attached to the blade irons below the motor housing. The blades have, in most cases, been made of rigid materials such as wood or rigid synthetic materials.

The present invention deals with a new type of windmill ceiling fan design not previously known to the market. While the design includes certain of the mechanical elements common to the traditional ceiling fan design discussed above, it also includes novel elements of appearance and structural design. One striking feature of the design is that it is reminiscent of the “Mykonos” windmill. The “Mykonos” windmills are iconic feature of the Greek island of the Mykonos. The island is one of the Cyclades islands, which neighbour Delos in the Aegean Sea. The windmills can be seen from every point of the village of Mykonos, the island's principal village. There are a currently some 16 surviving windmills on Mykonos of which seven are positioned on the landmark hill in Chora. Most of them were built by the Venetians in the 16th century, but their construction continued into the early 20th century. They were primarily used to mill wheat. They were an important source of income for the inhabitants. Their use gradually declined until they ceased production in the middle of the 20th century. The architecture of the base of the windmills is similar in each case. All have a round shape, white color and a pointed roof and very small windows.

The windmill itself, namely the outside round-shaped moving contraption made out of wood, consists of 12 wooden antennas, each of them fitted with a triangle-shaped “wing” made out of heavy cotton fabric, typically the same fabric used to make sails. The windmill rotates to the direction of the wind, carrying the movement across to a central wooden axis, located inside, in the heart of the building, which in turn forces the grind stones into action.

A modern ceiling fan design reminiscent of or incorporating some of attributes of the appearance of the Mykonos Windmills could provide a pleasing esthetic feature in modern homes. However, the incorporation of such design features into a modern ceiling fan necessarily involves certain additional design considerations not previously encountered in traditional electric ceiling fan design. Also, it would be advantageous if the new ceiling fan design could overcome certain of the inherent shortcomings of traditional ceiling fan designs.

Conventional ceiling fans are generally standardized as a 3, 4, or 5 blade fan assembly attached to a quiet-running motor, often equipped with several speeds in revolutions per minute (RPM) to enable adjustment of the air flow provided by the fan under a variety of conditions. In recent designs some fans are designed to have more blades, or blades having unusual profiles or shapes. Further, heretofore the blades of such fans are constructed of rigid material. Adding more blades increases the weight and therefore the inertia of the fan, placing a greater load on the motor and in some cases increasing the sound levels produced by the fan.

Another characteristic of conventional ceiling fans places an upper limit on the number of blades. As the number of blades increases, the noise produced when operating the fan at higher speeds to produce greater air movenent becomes intrusive and detracts from the enjoyment of the ventilation provided by the fan. Moreover, operating such a fan at lower speeds may provide less air movement. Thus, conventional ceiling fans are a compromise between volume of air flow, sound levels, physical size appropriate to the dimensions of a typical residential room, and the comfort level available from a given configuration.

There is thus a need for an efficient, quiet indoor ceiling fan reminiscent of the Mykonos Windmills that provides improved performance to overcome the limitations of conventional ceiling fans.

### SUMMARY OF THE INVENTION

Accordingly, to meet the foregoing objectives, a blade assembly for a ceiling fan is disclosed, comprising a hub attached to a motor shaft and a plurality of fan blades each attached at an inward end to the hub and supported radially by an elongated leading edge member and an elongated trailing edge member joined to the leading edge member at its outward end through a third outer edge member. Each fan blade is formed of a fabric material removably disposed on the a leading edge member and the third outer edge member. The pitch of each blade is determined by the angular relationship of the trailing edge member relative to the leading edge member.

In a preferred embodiment, there are ten fan blades rigidly attached at uniform radial intervals around the hub, and the leading and trailing edge members of each blade are disposed in a respective first and second horizontal plane, wherein the second horizontal plane is disposed below the first horizontal plane to establish the angular relationship and the pitch of each blade. The angular relationship of the trailing edges of each blade may be within the range of 10 to 16 degrees downward relative to the respective leading edge of each blade. In some embodiments, the angular relationship of the trailing edges of each blade may be approximately 13 degrees downward relative to the respective leading edge of each blade.

In one aspect of the invention, each blade is formed of first and second layers of a cotton fabric having a leading edge hem for receiving the leading edge member and an outer edge hem for receiving the third member; wherein the cotton fabric is treated with a waterproof coating. In other embodiments, the fabric for the fan blades is selected from the group consisting of fabrics woven of cotton, wool, silk, linen, and synthetic fibers; and the fabric is treated with a waterproof coating.

In another aspect, each blade is formed by a single layer of a fabric having a leading edge hem for receiving the leading edge member and a trailing edge hem for receiving the trailing edge member. In other embodiments, each blade is formed by a single layer of fabric having a leading edge hem for receiving the leading edge member and an outer edge hem for receiving the third member.

In another aspect, each blade is formed by a first and second layer of fabric having a leading edge hem for receiving the leading edge member, an outer edge hem for receiving the third member, and trailing edge hem for receiving the trailing edge member. In other embodiments, each blade is formed by a single layer of fabric having a leading edge hem for receiving the leading edge member, an outer edge hem for receiving the third member, and trailing edge hem for receiving the trailing edge member;

In another aspect, the leading edge, trailing edge, and third members of the frame are formed of materials selected from the group consisting of galvanized iron, stainless steel, aluminum, and synthetic composite materials. The frame members may preferably be coated with paint.

Additional objects, features and advantages will be apparent in the written description which follows.

### BRIEF DESCRIPTION OF THE DRAWINGS

FIG. 1 illustrates a perspective view from above a ceiling fan, in accordance with an embodiment of the claimed invention;

FIG. 2 illustrates an exploded perspective view of the frame members of the embodiment of FIGS. 1 and 2, in accordance with an embodiment of the present invention; and

FIG. 3 illustrates a side view looking rearward, of a single fan blade assembly, in accordance with an embodiment of the present invention.

### DETAILED DESCRIPTION OF THE INVENTION

Accordingly, there is disclosed herein a windmill-type fan adapted to use as a ceiling fan for cooling indoor residential or office spaces. Windmills, long used for agricultural and utilities uses such as generating electricity or powering pump apparatus in water wells, or for powering flour or grist mills, are an efficient means of harnessing wind energy. Their configuration suggests that some features of their design may be advantageous for cooling indoor residential and office building spaces. Windmill blades are designed to efficiently convert the available wind speed to a maximum mechanical shaft speed for driving generators or pump assemblies. Combining these utilitarian features with the esthetic visual features and feel of a classic windmill blade design, such as the Mykonos windmill blade, could produce a novel utilitarian and also visually pleasing ceiling fan design suitable for use in modern day residential or commercial settings.

With these design concepts in mind, the invention is characterized by having multiple blades formed of fabric material to provide a large number of light-weight blades. The utility of this configuration provides more efficient air movement at lower shaft speeds and lower sound levels. The individual blades are evenly disposed around the hub of the fan motor and feature an angle of attack—the angular relationship between the leading and trailing edges of the fan blades—that provides an optimum balance between the volume of air movement and the sound levels produced by the air flow over the blades as they rotate through it. Further, the shape of the blades that concentrates most of the surface area of the blades near their outer ends mimics the blade profiles of windmills, thereby realizing a slightly greater efficiency of air flow.

The plurality of fan blades may each be attached at an inward end to the hub and supported radially by an elongated leading edge member and an elongated trailing edge member joined to the leading edge member at its outward end through a third outer edge member. The overall diameter of the fan 10 is defined by twice the length of the blades plus the diameter of the hub. The light weight structure of the fabric fan blades permits an overall diameter larger than that of conventional ceiling fans. In the illustrated embodiment, the overall diameter is approximately 6½ feet. The number of blades may also be balanced with factors such as the overall weight of the ceiling fan, the loads on the motor and its bearings, and the weight and costs of manufacture of the ceiling fan. The embodiment described herein is equipped with ten blades, a number that may be varied to suit a particular application.

In the description that follows, the blades of the illustrated fan are identical; accordingly, the features of a single blade are described, with reference numbers identifying the individual components and features. Features shown in multiple views bear the same reference numbers,

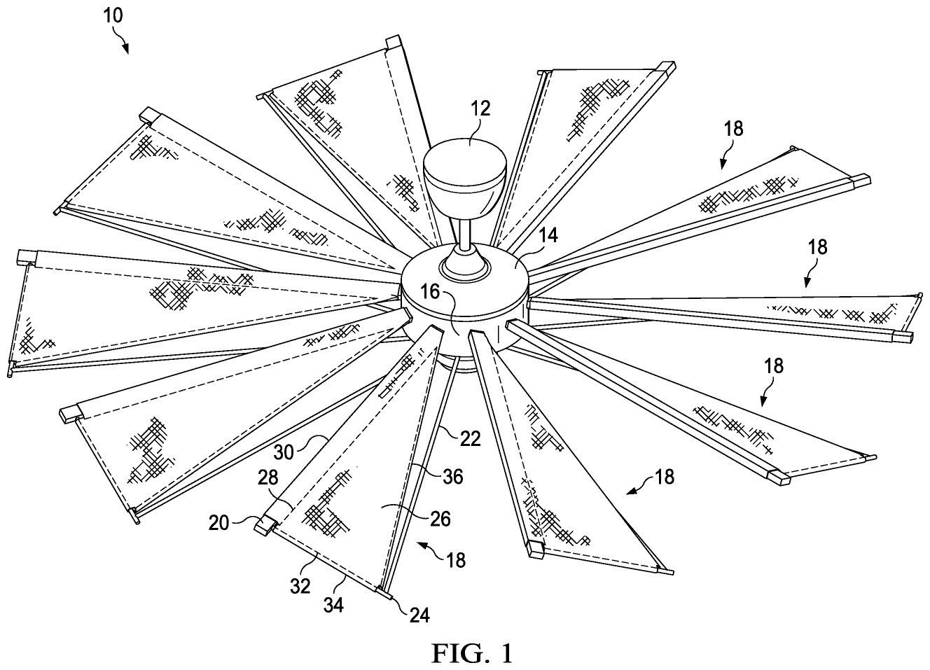

FIG. 1 illustrates a perspective view from above a ceiling fan 10, in accordance with one embodiment of the claimed invention. The ceiling fan 10 includes a support 12, a motor 14 suspended from the support 12, and a hub 16 driven by the motor 14. Attached to the hub 16 are a plurality of fan blades 18, arranged at even radial intervals around the hub 16. Each fan blade 18 includes a leading edge frame member 20, a trailing edge frame member 22, a third, outer edge frame member 24, and a canvas blade panel 26 that is attached to the leading edge member 20 and the third member 24 such as by a hem 28 formed into the leading edge 30 of the blade panel 26 and a second hem 32 formed into the outer edge 34 of the blade panel 26. The fan blade 18 has a trailing edge 36 formed as the edge of the canvas material of the blade panel 26. The structures described for the fan blade 18 in FIG. 1 are identical for all of the plurality of blades depicted in FIG. 1.

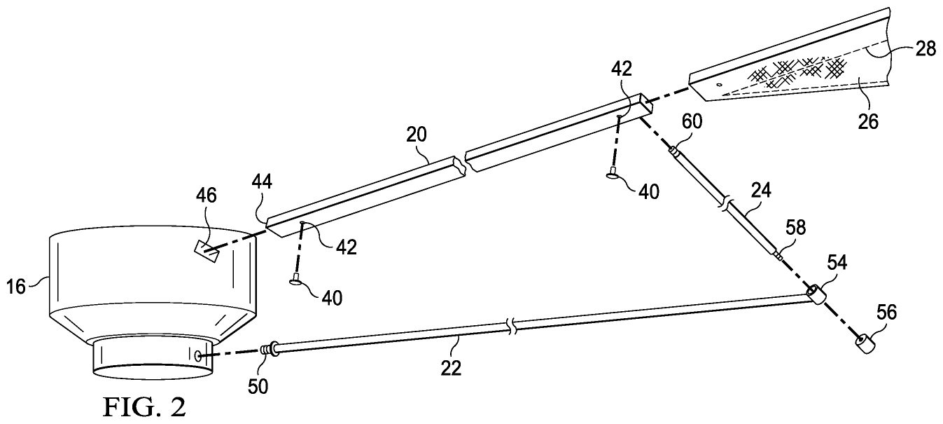

FIG. 2 illustrates an exploded perspective view of the frame members of the embodiment of FIG. 1, in accordance with one embodiment of the present invention. The leading edge frame member 20 includes an end 44 shaped to fit within a recess 46 in the hub 16. The leading edge 20 further includes holes 42 for receiving fasteners 40 to secure the fabric blade panel 26 to the leading edge member 20. The trailing edge 22 further includes a threaded end 50 to secure it in a threaded hole in the hub 16. The outer end of the trailing edge member 22 includes a bushing 54 for receiving a threaded end 58 of the third member 24 so it can be secured to the trailing edge member 22 with a threaded fastener 56. The opposite end of the third member 24 includes threads 60 to be threaded into a threaded hole 62 (not shown).

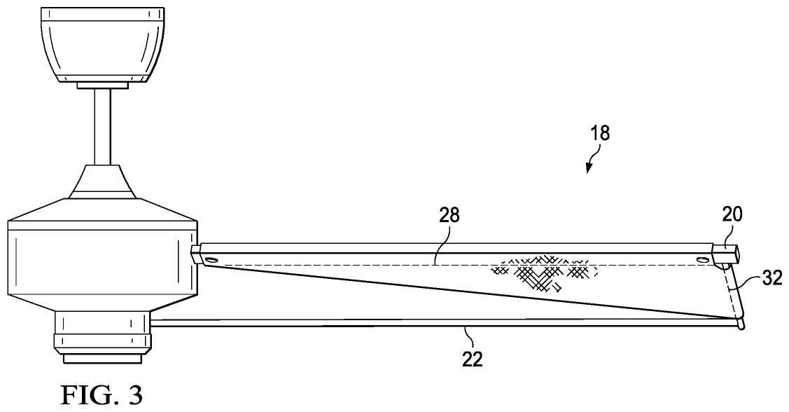

FIG. 3 illustrates a side view looking rearward, of a single fan blade assembly, in accordance with the embodiment of FIGS. 1 and 2 of the present invention. This view depicts the fabric fan blade 18 as it is disposed downward and away from the viewer. The pitch of each fan blade 18 is established by the relative position of the trailing edge member 22 with respect to the leading edge member 20. In this view the pitch—the angular relationship between the leading and trailing edges of the fan blades—should be approximately 13 degrees. In operation, the fan blade moves outward from the page as the fan blade assembly rotates.

Thus, the blade assembly for a ceiling fan 10 includes a hub 16 attached to the shaft of a motor 14; a plurality of fan blades 18 each attached at an inward end to the hub 16 and supported radially by an elongated leading edge member 20 and an elongated trailing edge member 22 joined to the leading edge member at its outward end by a third member 24. Each fan blade 18 is formed of a fabric material removably disposed on the leading edge member 20 and a third outer member 24 connected to the leading edge member 20. The pitch of each blade 18 is determined by the angular relationship of the trailing edge member 22 relative to the leading edge member 20.

There are preferably ten fan blades 18 rigidly attached at uniform radial intervals around the hub; and the leading edge 30 and trailing edge 36 members 20,22 of each blade 18 are disposed in—i.e., aligned within—a respective first and second horizontal plane as shown in FIG. 3. The second horizontal plane is disposed below the first horizontal plane to establish the angular relationship and the pitch of each blade 18. The angular relationship of the trailing edges 36 of each blade may be within the range of 10 to 16 degrees downward relative to the respective leading edge of each blade 18. Further, in a preferred embodiment, the angular relationship of the trailing edges of each blade 18 is approximately 13 degrees downward relative to the respective leading edge of each blade 18. In the illustrated embodiment, the leading edge, trailing edge, and third members are formed of galvanized iron and coated with paint.

Each blade 18 may be formed of a single layer of a fabric having a leading edge hem 28 for receiving the leading edge member 20 and an outer edge hem 32 for receiving the outer edge member 24. Alternatively, each blade 18 may be formed of first and second layers of the fabric having a leading edge hem 28 for receiving the leading edge member 20 and an outer edge hem for receiving the outer edge member 24. The fabric for the blade panels 26 is selected from the group consisting of fabrics woven of cotton, wool, silk, linen, and synthetic fibers; and the fabric is treated with a waterproof coating. The waterproof coating is important to ensure the fabric remains hydrophobic and dry. One non-functional attribute of fabric blade panels is that they may easily be made of different colors or patterns or other kinds of graphic images to adapt the ceiling fan to particular preferences, décor, etc.

The leading edge frame member 20, the trailing edge frame member 22, and the third outer edge frame member 24 may be formed of materials selected from the group consisting of galvanized iron, stainless steel, aluminum, and synthetic composite materials and coated with paint or powder coating. Aluminum frame members may be anodized. In a preferred embodiment, these members are galvanized iron coated with paint.

An invention has been provided with several advantages. The ceiling fan design of the invention incorporates the esthetically pleasing aspects of a traditional Mykonos windmill into a modern day electric ceiling fan design, accommodating for the architectural/mechanical requirements involved in such as adaptation.

The ceiling fan design of the invention also provides a number of structural/engineering advantages as have been outlined in the foregoing discussion.

While the invention defined in the appended claims has been shown and described herein in one of its forms, and several aspects or features of the invention have been illustrated by example, the invention is not limited by the exemplary illustrations herein but is susceptible to various alternatives, equivalents, changes, and modifications including the addition of features without departing from the basic concepts disclosed and claimed herein.

What is claimed is:

1. A ceiling fan assembly, comprising:
a ceiling support
a motor shaft depending downward from the ceiling support
a hub attached to the motor shaft;
a plurality of fan blades each attached at an inward end to the hub and supported radially by an elongated leading edge member and an elongated trailing edge member joined to the leading edge member at its outward end through a third outer edge member; and
each fan blade is formed of a fabric material removably disposed on at least the leading edge member; wherein
the pitch of each blade is determined by the angular relationship of the trailing edge member relative to the leading edge member.

2. The ceiling fan assembly of claim 1, wherein:
the third outer member is coupled to and detachable from the outward ends of the leading and trailing edge members.

3. The ceiling fan assembly of claim 1, wherein:
each blade is formed of first and second layers ofa cotton fabric having a leading edge hem for receiving the leading edge member and an outer edge hem for receiving the third member; wherein
the cotton fabric is treated with a waterproof coating.

4. The ceiling fan assembly of claim 1, wherein:
there are ten fan blades rigidly attached at uniform radial intervals around the hub; and
the leading and trailing edge members of each blade are disposed in a respective first and second horizontal plane; wherein the second horizontal plane is disposed below the first horizontal plane to establish the angular relationship and the pitch of each blade.

5. The ceiling fan assembly of claim 4, wherein:
the elongated third member intersects the first and second horizontal planes at the angular relationship.

6. The ceiling fan assembly of claim 1, wherein the angular relationship of the trailing edges of each blade is within the range of 10 to 16 degrees downward relative to the respective leading edge of each blade.

7. The ceiling fan assembly of claim 1, wherein the angular relationship of the trailing edges of each blade is approximately 13 degrees downward relative to the respective leading edge of each blade.

8. The ceiling fan assembly of claim 1, wherein:
the leading edge, trailing edge, and third members are formed of galvanized iron and coated with paint.

9. The ceiling fan assembly of claim 1, wherein:
each blade is formed of a single layer of a fabric having a leading edge hem for receiving the leading edge member and an outer edge hem for receiving the third member; wherein
the fabric is selected from the group consisting of fabrics woven of cotton, wool, silk, linen, and synthetic fibers; and
the fabric is treated with a waterproof coating.

10. The ceiling fan assembly of claim 1, wherein:
each blade is formed of first and second layers of a fabric having a leading edge hem for receiving the leading edge member and a trailing edge hem for receiving the trailing edge member; wherein
the fabric is selected from the group consisting of fabrics woven of cotton, wool, silk, linen, and synthetic fibers; and
the fabric is treated with a waterproof coating.

11. The ceiling fan assembly of claim 1, wherein:
each blade is formed of a single layer of a fabric having a leading edge hem for receiving the leading edge member and a trailing edge hem for receiving the trailing edge member; wherein
the fabric is selected from the group consisting of fabrics woven of cotton, wool, silk, linen, and synthetic fibers; and
the fabric is treated with a waterproof coating.

12. The ceiling fan assembly of claim 1, wherein:
each blade is formed of first and second layers of a fabric having a leading edge hem for receiving the leading edge member and an outer edge hem for receiving the third member; wherein
the fabric is selected from the group consisting of fabrics woven of cotton, wool, silk, linen, and synthetic fibers; and
the fabric is treated with a waterproof coating.

13. The ceiling fan assembly of claim 1, wherein:
each blade is formed of first and second layers of a fabric having a leading edge hem for receiving the leading edge member, an outer edge hem for receiving the third member, and trailing edge hem for receiving the trailing edge member; wherein
the fabric is selected from the group consisting of fabrics woven of cotton, wool, silk, linen, and synthetic fibers; and
the fabric is treated with a waterproof coating.

14. The ceiling fan assembly of claim 1, wherein:
each blade is formed of a single layer of a fabric having a leading edge hem for receiving the leading edge member, an outer edge hem for receiving the third member, and trailing edge hem for receiving the trailing edge member; wherein
the fabric is selected from the group consisting of fabrics woven of cotton, wool, silk, linen, and synthetic fibers; and
the fabric is treated with a waterproof coating.

15. The ceiling fan assembly of claim 1, wherein:
the leading edge, trailing edge, and third members are formed of materials selected from the group consisting of galvanized iron, stainless steel, aluminum, and synthetic composite materials and coated with paint.

16. The ceiling fan assembly of claim 1, wherein:
the pitch of each fan blade is established by the relative position ofthe trailing edge member with respect to the leading edge member.
